(19) United States
(12) Patent Application Publication
(10) Pub. No.: US 2024/0283107 A1
(43) Pub. Date: Aug. 22, 2024

(54) ELECTROCHEMICAL APPARATUS AND ELECTRIC DEVICE

(71) Applicant: Ningde Amperex Technology Limited, Ningde (CN)

(72) Inventors: Shiwei SU, Ningde (CN); Daolin DENG, Ningde (CN); Xingfu YANG, Ningde (CN); Wen CHEN, Ningde (CN)

(73) Assignee: Ningde Amperex Technology Limited, Ningde (CN)

(21) Appl. No.: 18/648,981

(22) Filed: Apr. 29, 2024

Related U.S. Application Data
(63) Continuation of application No. PCT/CN2021/127691, filed on Oct. 29, 2021.

(51) Int. Cl. H01M 50/538; H01M 4/36; H01M 10/04; H01M 50/109; H01M 50/247; H01M 50/503

(52) U.S. Cl. CPC H01M 50/538; H01M 4/366; H01M 10/0427; H01M 10/0431; H01M 50/109; H01M 50/247; H01M 50/503

(57) ABSTRACT

An electrochemical apparatus, including a housing, an electrode assembly, a first tab, a first connecting member, a second tab, and a second connecting member. The housing includes a top wall, a side wall, and a bottom wall, the top wall being provided with a first electrode. The electrode assembly includes a first electrode plate and a second electrode plate. The first tab is connected to the first electrode plate and the first electrode, and the first connecting member is connected to the first electrode. The second tab is connected to the second electrode plate and the housing, and the second connecting member is connected to the housing. When the electrochemical apparatus is in a charging/discharging state, a magnetic field generated by the electrochemical apparatus is weakened, reducing electromagnetic interference of the electrochemical apparatus to an electric device.

### CROSS-REFERENCE TO RELATED APPLICATIONS

This application is a continuation application of PCT International Application No. PCT/CN2021/127691, filed on Oct. 29, 2021, the contents of which are incorporated herein by reference in its entirety.

### TECHNICAL FIELD

This application relates to the field of energy storage technologies, and particularly to an electrochemical apparatus and an electric device.

### BACKGROUND

Button cells are widely used in Bluetooth headsets, but the noise floor generated by the magnetic field of the button cell itself can affect the sound effect of the Bluetooth headset, thus compromising user experience.

### SUMMARY

In view of the above situation, it is necessary to provide an electrochemical apparatus to reduce electromagnetic interference to an electric device.

According to a first aspect of this application, an electrochemical apparatus is provided. The electrochemical apparatus includes a housing and an electrode assembly accommodated in the housing. The housing includes a top wall, a side wall, and a bottom wall, the top wall being provided with a first electrode. The electrode assembly includes a first electrode plate and a second electrode plate. The electrochemical apparatus satisfies at least one of the following conditions (i) or (ii): (i) the electrochemical apparatus further includes a first tab and a first connecting member disposed outside the housing; the first tab is connected to the first electrode plate and the first electrode, and the first tab includes a first connecting zone connected to the first electrode plate; and the first connecting member is connected to the first electrode; where when viewed in a direction perpendicular to the top wall, a connecting line between a geometric center of the first connecting zone and a geometric center of the first electrode is a first reference line, and with the geometric center of the first electrode as the center of a circle and a length L1 of a line segment between the geometric center of the first connecting zone and the geometric center of the first electrode as a radius, a ±45° sector region on both sides of the first reference line is denoted as a first region, an area of the first connecting member is denoted as S1, and an area of an overlap between the first connecting member and the first region is denoted as S2, satisfying: S2/S1≥50%; or (ii) the electrochemical apparatus further includes a second tab and a second connecting member disposed outside the housing; the second tab is connected to the second electrode plate and the housing, and the second tab includes a second connecting zone connected to the second electrode plate and a third connecting zone connected to the housing; and the second connecting member is connected to the housing; where when viewed in a direction perpendicular to the bottom wall, a connecting line between a geometric center of the second connecting zone and a geometric center of the third connecting zone is a second reference line, and with the geometric center of the third connecting zone as the center of a circle and a length L2 of a line segment between the geometric center of the second connecting zone and the geometric center of the third connecting zone as a radius, a ±45° sector region on both sides of the second reference line is denoted as a second region, an area of the second connecting member is denoted as S3, and an area of an overlap between the second connecting member and the second region is denoted as S4, satisfying: S4/S3≥50%. When the electrochemical apparatus is in a charging/discharging state, a magnetic field generated by the first tab and a magnetic field generated by the first connecting member can at least partially cancel each other out, and/or a magnetic field generated by the second tab and a magnetic field generated by the second connecting member can at least partially cancel each other out, so that a magnetic field generated at an end face of the electrochemical apparatus is weakened. As compared with other values of S2/S1 and/or S4/S3, when S2/S1≥50% and/or S4/S3≥50%, the magnetic field at the end face of the electrochemical apparatus is weak and causes less electromagnetic interference to an electric device.

In some embodiments of this application, the electrochemical apparatus further satisfies at least one of the following conditions (iii) or (iv): (iii) S2/S1≥70%; or (iv) S4/S3≥70%. When S2/S1≥70% and/or S4/S3≥70%, the magnetic field generated at the end face of the electrochemical apparatus is smaller, and the difference in magnetic field strength at various positions of the end face is small.

In some embodiments of this application, the electrochemical apparatus further satisfies at least one of the following conditions (v) or (vi): (v) a fourth connecting zone is provided at an end portion of the first connecting member away from the first electrode, where when viewed in a direction perpendicular to the top wall, an included angle between a connecting line between a geometric center of the fourth connecting zone and the geometric center of the first electrode and a connecting line between the geometric center of the first connecting zone and the geometric center of the first electrode is denoted as θ, satisfying: 0°≤θ≤45°; or (vi) a fifth connecting zone is provided at an end portion of the second connecting member away from the third connecting zone, where when viewed in a direction perpendicular to the bottom wall, an included angle between a connecting line between a geometric center of the fifth connecting zone and the geometric center of the third connecting zone and a connecting line between the geometric center of the second connecting zone and the geometric center of the third connecting zone is denoted as ß, satisfying: 0°≤β≤45°.

As compared with θ>45°, when θ≤45°, the magnetic field generated by the first tab and the magnetic field generated by the first connecting member cancel each other out better, and the electrochemical apparatus has better electromagnetic characteristics. As compared with β>45°, when β≤45°, the magnetic field generated by the second tab and the magnetic field generated by the second connecting member cancel each other out better, and the electrochemical apparatus has better electromagnetic characteristics.

In some embodiments of this application, a fourth connecting zone is provided at an end portion of the first connecting member away from the first electrode. When viewed in a direction perpendicular to the top wall, a connecting line between a geometric center of the fourth connecting zone and the geometric center of the first electrode is a third reference line, and with the geometric center of the first electrode as the center of a circle and a length L3 of a line segment between the geometric center of the fourth connecting zone and the geometric center of the first electrode as a radius, a ±45° sector region on both sides of the third reference line is denoted as a third region, and an area of an overlap between the second connecting member and the third region is denoted as S5, satisfying: S5/S3≥50%. When the electrochemical apparatus is in a charging/discharging state, the magnetic field generated by the first connecting member and the magnetic field generated by the second connecting member can at least partially cancel each other out, so that a magnetic field generated by the entire electrochemical apparatus is weakened. As compared with S5/S3≥50%, when S5/S3≥50%, the magnetic field generated by the first connecting member and the magnetic field generated by the second connecting member cancel each other out better, and the electrochemical apparatus has better electromagnetic characteristics.

In some embodiments of this application, a ratio of the area S5 to the area S3 satisfies: S5/S3≥85%. When S5/S3≥85%, the magnetic field generated by the first connecting member and the magnetic field generated by the second connecting member cancel each other out better, and the difference in magnetic field strength at various positions of the end face is small.

In some embodiments of this application, when viewed in the direction perpendicular to the top wall, an included angle between the first reference line and the second reference line is denoted as a, satisfying: 0°≤α≤60°. As compared with α>60°, when 0°≤α≤60°, the magnetic field generated by the first tab and the magnetic field generated by the second tab cancel each other out better, and a magnetic field generated by the entire electrochemical apparatus is smaller.

In some embodiments of this application, the electrode assembly is a wound structure. The first electrode plate includes a first active material layer, the first active material layer includes a first end portion, and the first end portion is disposed at a winding start end of the wound structure. The second electrode plate includes a second active material layer, the second active material layer includes a second end portion, and the second end portion is disposed at the winding start end of the wound structure. Along a length direction of the first electrode plate, a distance between the geometric center of the first connecting zone and the first end portion is denoted as D1; and along a length direction of the second electrode plate, a distance between the geometric center of the second connecting zone and the second end portion is denoted as D2, satisfying: 0.5≤D1/D2≤2. As compared with other values of D1/D2, when 0.5≤D1/D2≤2, a magnetic field generated by the first electrode plate and a magnetic field generated by the second electrode plate cancel each other out better, and the magnetic field generated by the electrochemical apparatus has smaller impact on the electric device. Further, when 0.9≤D1/D2≤1.1, the magnetic field generated by the first electrode plate and the magnetic field generated by the second electrode plate cancel each other out better, and the difference in magnetic field strength at various positions of the end face of the electrochemical apparatus is small.

In some embodiments of this application, the electrochemical apparatus further satisfies at least one of the following conditions (a) or (b): (a) a fourth connecting zone is provided at an end portion of the first connecting member away from the first electrode, where when viewed in a direction perpendicular to the top wall, a length of a line segment between a geometric center of a fourth connecting zone and the geometric center of the first electrode is denoted as L3, satisfying: 0.5≤L1/L3≤2; or (b) a fifth connecting zone is provided at an end portion of the second connecting member away from the third connecting zone, where when viewed in a direction perpendicular to the bottom wall, a length of a line segment between a geometric center of the fifth connecting zone and the geometric center of the third connecting zone is denoted as L4, satisfying: 0.5≤L2/L4≤2.

As compared with other values of L1/L3, when 0.5≤L1/L3≤2, the magnetic field generated by the first tab and the magnetic field generated by the first connecting member cancel each other out better, and the difference in magnetic field strength at various positions on the top wall side of the electrochemical apparatus is smaller. As compared with other values of L2/L4, when 0.5≤L2/L4≤2, the magnetic field generated by the second tab and the magnetic field generated by the second connecting member cancel each other out better, and the difference in magnetic field strength at various positions on the bottom wall side of the electrochemical apparatus is smaller.

In some embodiments of this application, the electrochemical apparatus further satisfies at least one of the following conditions (1) to (4): (1) the first tab and the second tab are located on opposite sides of the electrode assembly; (2) the top wall has a first surface and a second surface opposite each other, the top wall is provided with a through hole penetrating through the first surface and the second surface, and the first electrode is disposed in the through hole; (3) an insulator is provided between the top wall and the first electrode; or (4) the housing includes a metal material.

According to a second aspect of this application, an electric device is further provided, the electric device including the electrochemical apparatus according to any one of the foregoing embodiments. The electrochemical apparatus can weaken the magnetic field generated by itself, has good electromagnetic characteristics, and reduces the impact of its own magnetic field on the electric device.

### BRIEF DESCRIPTION OF DRAWINGS

FIG. 1 is a first view of an electrochemical apparatus according to an embodiment of this application.

FIG. 2 is a second view of an electrochemical apparatus according to an embodiment of this application.

FIG. 3 is a partial cross-sectional view of an electrochemical apparatus according to an embodiment of this application.

FIG. 4 is a schematic structural diagram of a first electrode according to an embodiment of this application.

FIG. 5 is a first view of an electrode assembly, a first tab, and a second tab according to an embodiment of this application.

FIG. 6 is a second view of an electrode assembly, a first tab, and a second tab according to an embodiment of this application.

FIG. 7 is a third view of an electrochemical apparatus according to an embodiment of this application.

FIG. 8 is a third view of an electrode assembly, a first tab, and a second tab according to an embodiment of this application.

FIG. 9 is a fourth view of an electrochemical apparatus according to another embodiment of this application.

FIG. 10 is a fifth view of an electrochemical apparatus according to an embodiment of this application.

FIG. 11 is a sixth view of an electrochemical apparatus according to an embodiment of this application.

FIG. 12 is a schematic structural diagram of an electric device according to an embodiment of this application.

### REFERENCE SIGNS OF MAIN COMPONENTS

Electrochemical apparatus 100
Housing 1
Top wall 11
First electrode 111
First portion 1111
Third surface 1111a
Second portion 1112
First surface 112
Second surface 113
Through hole 114
Side wall 12
Bottom wall 13
Conductive portion 131
Cavity space 14
Electrode assembly 2
First electrode plate 21
First active material layer 211
First end portion 2111
Second electrode plate 22
Second active material layer 221
Second end portion 2211
Separator 23
First tab 3
First connecting zone 31
Second tab 4
Second connecting zone 41
Third connecting zone 42
First connecting member 5
Fourth connecting zone 51
Second connecting member 6
Fifth connecting zone 61
Insulator 7
Connecting line between geometric center of fourth W1 connecting zone and geometric center of first electrode
Connecting line between geometric center of first W2 connecting zone and geometric center of first electrode
Connecting line between geometric center of fifth W3 connecting zone and geometric center of third connecting zone
Connecting line between geometric center of second W4 connecting zone and geometric center of third connecting zone
Length of line segment between geometric center of first L1 connecting zone and geometric center of first electrode
Length of line segment between geometric center of second connecting zone and geometric center of third connecting L2 zone
Length of line segment between geometric center of L3 fourth connecting zone and geometric center of first electrode
Length of line segment between geometric center of fifth L4 connecting zone and geometric center of third connecting zone
First region A1
Second region A2
Third region A3
Electric device 200
Device body 210
First direction X
Second direction Y
Third direction Z

This application will be further described with reference to the accompanying drawings in the following specific embodiments.

### DETAILED DESCRIPTION

The following describes the technical solutions in some embodiments of this application with reference to the accompanying drawings in these embodiments of this application. Apparently, the described embodiments are only some rather than all of the embodiments of this application.

It should be noted that when one component is assumed as being “connected to” another component, it may be connected to the another component directly or with a component possibly present therebetween. When a component is deemed as being “disposed” on another component, it may be directly disposed on the another component, or there may be a component disposed in between.

Unless otherwise defined, all technical and scientific terms used herein shall have the same meanings as commonly understood by those skilled in the art to which this application pertains. The terms used in the specification of this application are intended to merely describe the specific embodiments rather than to limit this application.

According to a first aspect of this application, an electrochemical apparatus is provided, including a housing and an electrode assembly accommodated in the housing. The housing includes a top wall, a side wall, and a bottom wall, the top wall being provided with a first electrode. The electrode assembly includes a first electrode plate and a second electrode plate. The electrochemical apparatus satisfies at least one of the following conditions (i) or (ii): (i) the electrochemical apparatus further includes a first tab and a first connecting member disposed outside the housing; the first tab is connected to the first electrode plate and the first electrode, and the first tab includes a first connecting zone connected to the first electrode plate; and the first connecting member is connected to the first electrode; where when viewed in a direction perpendicular to the top wall, a connecting line between a geometric center of the first connecting zone and a geometric center of the first electrode is a first reference line, and with the geometric center of the first electrode as the center of a circle and a length L1 of a line segment between the geometric center of the first connecting zone and the geometric center of the first electrode as a radius, a ±45° sector region on both sides of the first reference line is denoted as a first region, an area of the first connecting member is denoted as S1, and an area of an overlap between the first connecting member and the first region is denoted as S2, satisfying: S2/S1 ≥50%; or (ii) the electrochemical apparatus further includes a second tab and a second connecting member disposed outside the housing; the second tab is connected to the second electrode plate and the housing, and the second tab includes a second connecting zone connected to the second electrode plate and a third connecting zone connected to the housing; and the second connecting member is connected to the housing; where when viewed in a direction perpendicular to the bottom wall, a connecting line between a geometric center of the second connecting zone and a geometric center of the third connecting zone is a second reference line, and with the geometric center of the third connecting zone as the center of a circle and a length L2 of a line segment between the geometric center of the second connecting zone and the geometric center of the third connecting zone as a radius, a ±45° sector region on both sides of the second reference line is denoted as a second region, an area of the second connecting member is denoted as S3, and an area of an overlap between the second connecting member and the second region is denoted as S4, satisfying: S4/S3≥50%. When the electrochemical apparatus is in a charging/discharging state, a magnetic field generated by the first tab and a magnetic field generated by the first connecting member can at least partially cancel each other out, and/or a magnetic field generated by the second tab and a magnetic field generated by the second connecting member can at least partially cancel each other out, so that a magnetic field generated at an end face of the electrochemical apparatus is weakened. As compared with other values of S2/S1 and/or S4/S3, when S2/S1≥50% and/or S4/S3≥50%, the magnetic field at the end face of the electrochemical apparatus is weak and causes less electromagnetic interference to an electric device.

In an example, further description will be made with an example in which the electrochemical apparatus is placed on the horizontal plane, with the bottom wall at the bottom and the top wall at the top.

The following further describes some embodiments of this application with reference to the accompanying drawings.

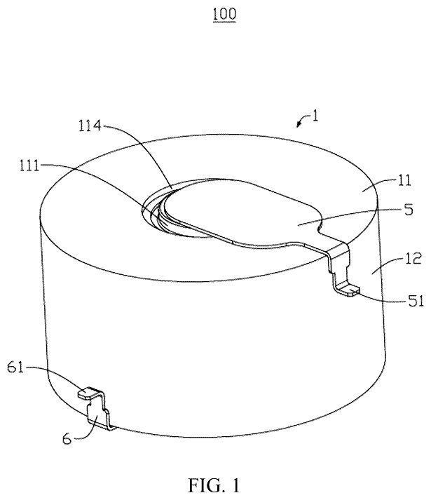

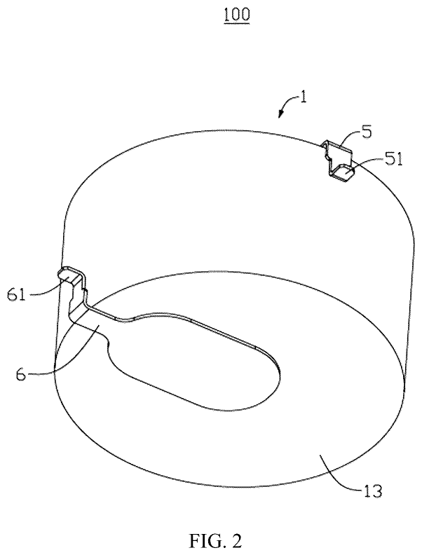

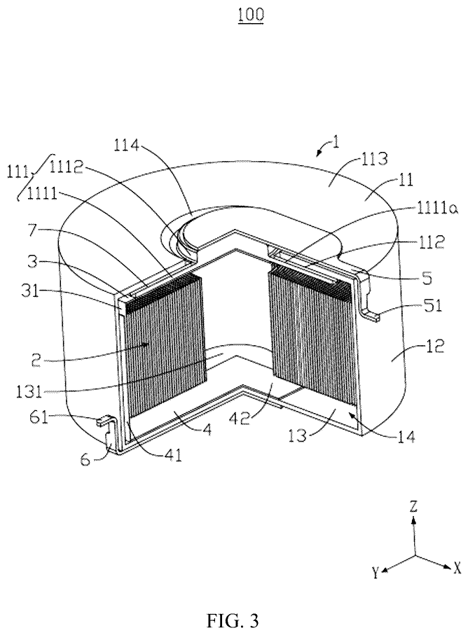

As shown in FIG. 1, FIG. 2, and FIG. 3, an embodiment of this application provides an electrochemical apparatus 100. The electrochemical apparatus 100 includes a housing 1, an electrode assembly 2, a first tab 3, a second tab 4, a first connecting member 5, and a second connecting member 6. The electrode assembly 2, the first tab 3, and the second tab 4 are disposed inside the housing 1, and the electrode assembly 2 connects the first tab 3 and the second tab 4. The first connecting member 5 and the second connecting member 6 are disposed outside the housing 1, the first connecting member 5 is electrically connected to the first tab 3, and the second connecting member 6 is electrically connected to the second tab 4. The first connecting member 5 and the second connecting member 6 can be used to connect an external electric device, so that the electrochemical apparatus 100 can supply power to the electric device.

The housing 1 includes a top wall 11, a side wall 12, and a bottom wall 13. The top wall 11, the side wall 12, and the bottom wall 13 enclose a cavity space 14, and the electrode assembly 2, the first tab 3, and the second tab 4 are disposed in the cavity space 14.

The top wall 11 is provided with a first electrode 111. The first electrode 111 connects the first tab 3 and the first connecting member 5.

In an embodiment, the top wall 11 is provided with a through hole 114 and includes a first surface 112 and a second surface 113 facing away from each other. The through hole 114 penetrates through the first surface 112 and the second surface 113. The first surface 112 is located on a side of the top wall 11 facing the cavity space 14, and the second surface 113 is located on a side of the top wall 11 facing away from the cavity space 14.

At least part of the first electrode 111 is disposed in the through hole 114. In an embodiment, the electrochemical apparatus 100 further includes an insulator 7. The insulator 7 is disposed between the top wall 11 and the first electrode 111. The insulator 7 connects the top wall 11 and the first electrode 111 and insulates the top wall 11 from the first electrode 111, reducing the risk of short circuit in the electrochemical apparatus 100.

In an embodiment, the material of the first electrode 111 includes but is not limited to aluminum or copper metal.

In an embodiment, the bottom wall 13 includes a conductive portion 131. The conductive portion 131 connects the second tab 4 and the second connecting member 6 so that the second tab 4 is electrically connected to the second connecting member 6. In an embodiment, the conductive portion 131 includes a metal material.

In an embodiment, the first connecting member 5 includes a metal material. In an embodiment, the second connecting member 6 includes a metal material.

In other embodiments, the first electrode 111 may alternatively be disposed in the through hole 114 (not shown in the figure), and the insulator 7 is disposed between the first electrode 111 and the inner wall of the through hole 114.

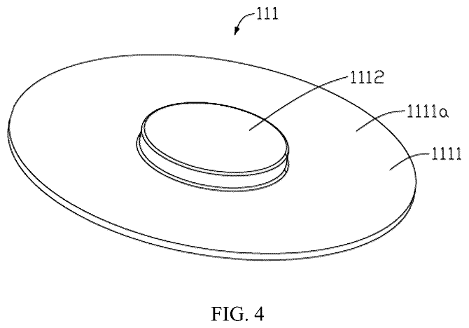

As shown in FIG. 3 and FIG. 4, the first electrode 111 includes a first portion 1111 and a second portion 1112. The first portion 1111 has a third surface 1111a, and the second portion 1112 protrudes from the third surface 1111a. The first portion 1111 is disposed in the cavity space 14, and the second portion 1112 is in the through hole 114.

For ease of understanding and description, further description will be made below with an example in which a direction perpendicular to the top wall 11 is a third direction Z; and when viewed in the third direction Z, a length direction of the first connecting member 5 is a first direction X, and a length direction of the second connecting member 6 is a second direction Y.

In an embodiment, the insulator 7 has a ring structure, and the second portion 1112 of the first electrode 111 passes through the ring structure.

In an embodiment, the insulator 7 includes but is not limited to sealant.

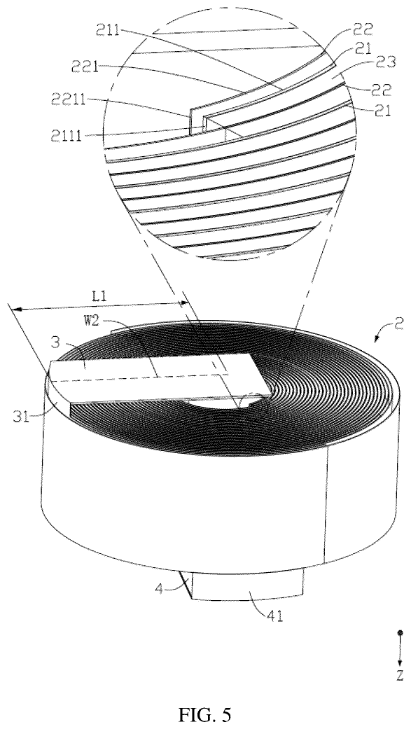

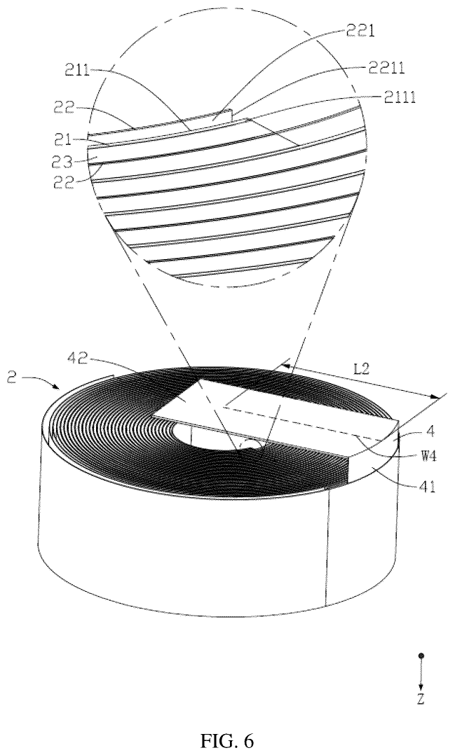

As shown in FIG. 5 and FIG. 6, the electrode assembly 2 includes a first electrode plate 21, a second electrode plate 22, and a separator 23, and the separator 23 is disposed between the first electrode plate 21 and the second electrode plate 22. In an embodiment, the first electrode plate 21, the separator 23, and the second electrode plate 22 are wound together.

One of the first electrode plate 21 and the second electrode plate 22 is a positive electrode plate and the other is a negative electrode plate.

One of the first tab 3 and the second tab 4 is a positive electrode tab and the other is a negative electrode tab.

The first electrode plate 21 includes a first active material layer 211, the first tab 3 has a first connecting zone 31, and the first tab 3 is connected to the first electrode plate 21 at the first connecting zone 31.

The second electrode plate 22 includes a second active material layer 221, the second tab 4 has a second connecting zone 41, and the second tab 4 is connected to the second electrode plate 22 at the second connecting zone 41.

In an embodiment, the first tab 3 is located on a side of the electrode assembly 2, and the second tab 4 is located on the opposite side of the electrode assembly 2. In other embodiments, the first tab 3 and the second tab 4 may alternatively be located on a same side of the electrode assembly 2 (not shown in the figure).

The electrode assembly 2 is a wound structure. In an embodiment, the first active material layer 211 includes a first end portion 2111, and the first end portion 2111 is disposed at a winding start end of the wound structure; and the second active material layer 221 includes a second end portion 2211, and the second end portion 2211 is disposed at the winding start end of the wound structure.

Along a length direction of the first electrode plate 21, a distance between a geometric center of the first connecting zone 31 and the first end portion 2111 is denoted as D1. Along a length direction of the second electrode plate 22, a distance between a geometric center of the second connecting zone 41 and the second end portion 2211 is denoted as D2 Optionally, 0.5≤D1/D2≤2.

When the electrochemical apparatus 100 is in a charging/discharging state, a current direction between the first end portion 2111 and the first connecting zone 31 is opposite to a current direction between the second end portion 2211 and the second connecting zone 41, and magnetic fields generated by opposite currents in the first electrode plate 21 and the second electrode plate 22 can at least partially cancel each other out, thereby reducing the impact of a magnetic field generated by the electrochemical apparatus 100 on the electric device.

Further optionally, 0.9≤D1/D2≤1.1. When 0.9≤D1/D2≤1.1, the magnetic field generated by the first electrode plate 21 and the magnetic field generated by the second electrode plate 22 cancel each other out better, and the difference in magnetic field strength at various positions of the end face of the electrochemical apparatus 100 is small.

Referring to FIG. 1, FIG. 2, and FIG. 3, the second tab 4 further has a third connecting zone 42, and the second tab 4 is connected to the conductive portion 131 of the bottom wall 13 at the third connecting zone 42.

A fourth connecting zone 51 is provided at an end portion of the first connecting member 5 away from the first electrode 111, and a fifth connecting zone 61 is provided at an end portion of the second connecting member 6 away from the third connecting zone 42. The fourth connecting zone 51 and the fifth connecting zone 61 can be used to connect an external electric device, so that the electrochemical apparatus 100 can be electrically connected to the electric device.

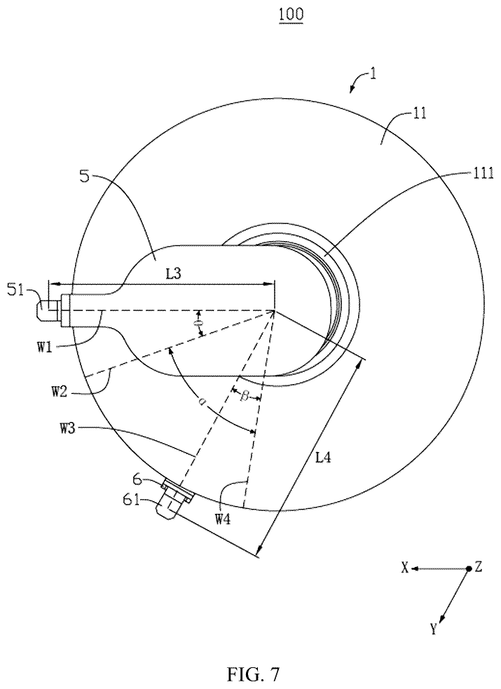

Referring to FIG. 5, FIG. 6, and FIG. 7, when viewed in the third direction Z, a connecting line between a geometric center of the fourth connecting zone 51 and the geometric center of the first electrode 111 is denoted as W1, a connecting line between the geometric center of the first connecting zone 31 and the geometric center of the first electrode 111 is denoted as W2, and an included angle between the connecting line W1 and the connecting line W2 is denoted as θ.

In this application, θ is the included angle between a ray passing through the geometric center of the fourth connecting zone 51 and a ray passing through the geometric center of the first connecting zone 31 when viewed in the third direction Z, with the geometric center of the first electrode 111 as an endpoint.

In an embodiment, 0°≤θ≤45°. When the electrochemical apparatus 100 is in a charging/discharging state, when viewed in the third direction Z, currents tend to flow in opposite directions on the first tab 3 and the first connecting member 5, and the magnetic field generated by the first tab 3 and the magnetic field generated by the first connecting member 5 can at least partially cancel each other out, so that the magnetic field generated on the side of the top wall 11 of the electrochemical apparatus 100 is weakened, thereby reducing the impact of the magnetic field generated by the electrochemical apparatus 100 on the electric device. As compared with θ>45°, when θ≤45°, the magnetic field generated by the first tab 3 and the magnetic field generated by the first connecting member 5 cancel each other out better, and the electrochemical apparatus 100 has better electromagnetic characteristics.

When viewed in the third direction Z, a connecting line between a geometric center of the fifth connecting zone 61 and a geometric center of the third connecting zone 42 is denoted as W3, a connecting line between the geometric center of the second connecting zone 41 and the geometric center of the third connecting zone 42 is denoted as W4, and an included angle between the connecting line W3 and the connecting line W4 is denoted as β.

In this application, β is the included angle between a ray passing through the geometric center of the fifth connecting zone 61 and a ray passing through the geometric center of the second connecting zone 41 when viewed in the third direction Z, with the geometric center of the third connecting zone 42 as an endpoint.

In an embodiment, 0°≤β≤45°. When the electrochemical apparatus 100 is in a charging/discharging state, when viewed in the third direction Z, the currents tend to flow in opposite directions on the second tab 4 and the second connecting member 6, and the magnetic field generated by the second tab 4 and the magnetic field generated by the second connecting member 6 can at least partially cancel each other out, so that the magnetic field generated on the side of the bottom wall 13 of the electrochemical apparatus 100 is weakened, thereby reducing the impact of the magnetic field generated by the electrochemical apparatus 100 on the electric device. As compared with β>45°, when β≤45°, the magnetic field and inductance generated by the second tab 4 and the magnetic field and inductance generated by the second connecting member 6 cancel each other out better, and the electrochemical apparatus 100 has better electromagnetic characteristics.

When viewed in the third direction Z, a length of a line segment between the geometric center of the first connecting zone 31 and the geometric center of the first electrode 111 is denoted as L1, and a length of a line segment between the geometric center of the fourth connecting zone 51 and the geometric center of the first electrode 111 is denoted as L3.

Optionally, 0.5≤L1/L3≤2. As compared with other values of L1/L3, when 0.5≤L1/L3≤2, the magnetic field generated by the first tab 3 and the magnetic field generated by the first connecting member 5 cancel each other out better, and the magnetic field generated by the electrochemical apparatus 100 has smaller impact on the electric device. Optionally, 0.9≤L1/L3≤1.1.

When viewed in the third direction Z, a length of a line segment between the geometric center of the second connecting zone 41 and the geometric center of the third connecting zone 42 is denoted as L2, and a length of a line segment between the geometric center of the fifth connecting zone 61 and the geometric center of the third connecting zone 42 is denoted as L4.

In an embodiment, 0.5≤L2/L4≤2. As compared with other values of L2/L4, when 0.5≤L2/L4≤2, the magnetic field generated by the second tab 4 and the magnetic field generated by the second connecting member 6 cancel each other out better, and the magnetic field generated by the electrochemical apparatus 100 has smaller impact on the electric device. Optionally, 0.9≤L2/L4≤1.1.

In an embodiment, an included angle between the connecting line W2 and the connecting line W4 is denoted as a, and optionally, 0°≤α≤60°. When the electrochemical apparatus 100 is in a charging/discharging state, the magnetic field generated by the first tab 3 and the magnetic field generated by the second tab 4 can at least partially cancel each other out, so that the magnetic field generated by the entire electrochemical apparatus 100 is weakened, thereby reducing the impact of the magnetic field generated by the electrochemical apparatus 100 on the electric device. In this application, the included angle α is an included angle between a ray from an intersection point between the connecting line W2 and the connecting line W4 or their extension lines to the geometric center of the first connecting zone 31 and a ray from the intersection point to the geometric center of the second connecting zone 41.

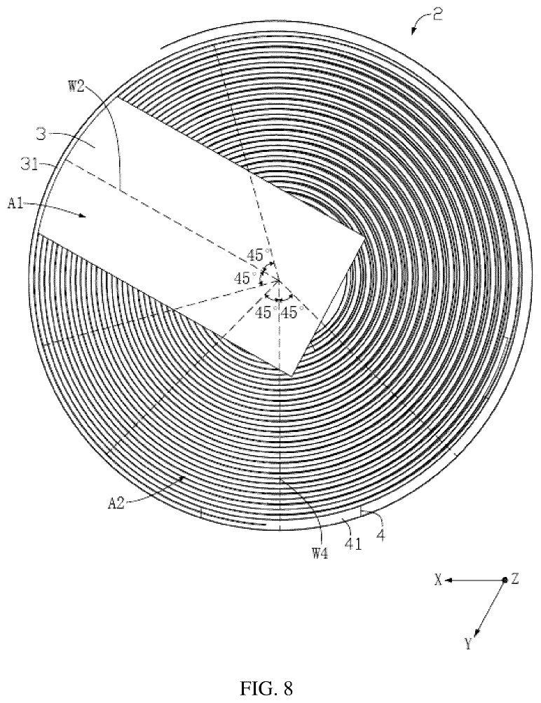

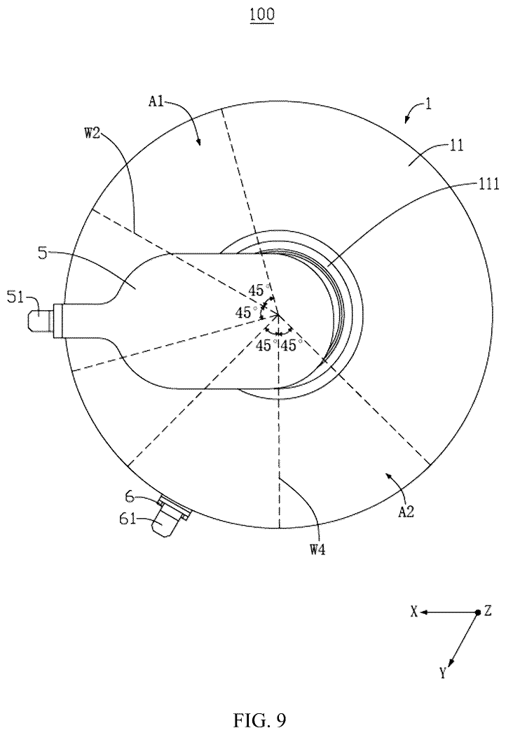

As shown in FIG. 8 and FIG. 9, when viewed in the third direction Z, with the connecting line W2 as a first reference line, the geometric center of the first electrode 111 as the center of a circle, and the line segment length L1 as a radius, α±45° sector region on both sides of the first reference line is denoted as a first region A1, an area of the first connecting member 5 is denoted as S1, and an area of an overlap between the first connecting member 5 and the first region A1 is denoted as S2.

Optionally, S2/S1≥50%. As compared with S2/S1<50%, when S2/S1≥50%, the magnetic field generated by the first tab 3 and the magnetic field generated by the first connecting member 5 cancel each other out better, and the magnetic field generated on the side of the top wall 11 of the electrochemical apparatus 100 has smaller impact on the electric device.

Optionally, S2/S1≥70%. When S2/S1≥70%, the magnetic field generated by the first tab 3 and the magnetic field generated by the first connecting member 5 cancel each other out better, and the difference in magnetic field at various positions on the side of the top wall 11 is small.

In an embodiment, when viewed in the third direction Z, with the connecting line W4 as a second reference line, the geometric center of the third connecting zone 42 as the center of a circle, and the line segment length L2 as a radius, a ±45° sector region on both sides of the second reference line is denoted as a second region A2, an area of the second connecting member 6 is denoted as S3, and an area of an overlap between the second connecting member 6 and the second region A2 is denoted as S4.

Optionally, S4/S3≥50%. As compared with S4/S3<50%, when S4/S3≥50%, the magnetic field generated by the second tab 4 and the magnetic field generated by the second connecting member 6 cancel each other out better, and the magnetic field generated on the side of the bottom wall 13 of the electrochemical apparatus 100 has smaller impact on the electric device.

Further, S4/S3≥70%. When S4/S3≥70%, the magnetic field generated by the second tab 4 and the magnetic field generated by the second connecting member 6 cancel each other out better, and the difference in magnetic field at various positions on the side of the bottom wall 13 is small.

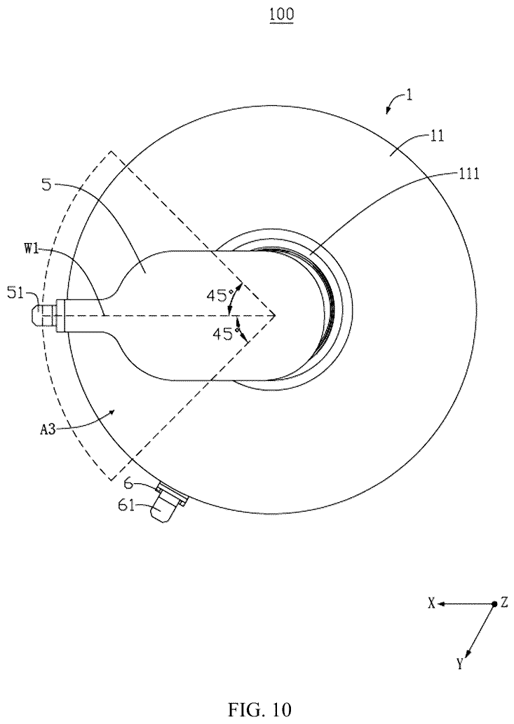

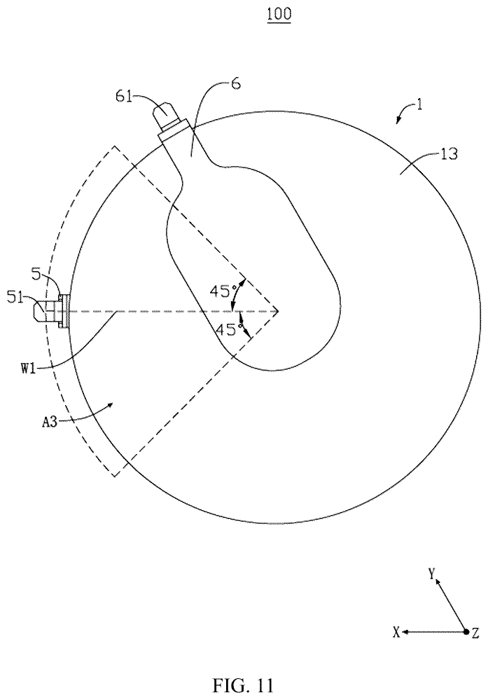

As shown in FIG. 10 and FIG. 11, in an embodiment, when viewed in the third direction Z, with the connecting line W1 as a third reference line, the geometric center of the first electrode 111 as the center of a circle, and the line segment length L3 as a radius, a ±45° sector region on both sides of the third reference line is denoted as a third region A3, and an area of an overlap between the second connecting member 6 and the third region A3 is denoted as S5.

In an embodiment, S5/S3≥50%. When the electrochemical apparatus 100 is in a charging/discharging state, the magnetic field generated by the first connecting member 5 and the magnetic field generated by the second connecting member 6 can at least partially cancel each other out, so that the magnetic field generated by the entire electrochemical apparatus 100 is weakened, thereby reducing the impact of the magnetic field generated by the electrochemical apparatus 100 on the electric device.

Optionally, S5/S3≥85%. When S5/S3≥85%, the magnetic field generated by the first connecting member 5 and the magnetic field generated by the second connecting member 6 cancel each other out better, and the difference in magnetic field at various positions on the sides of the top wall 11 and bottom wall 13 of the electrochemical apparatus 100 is small.

To verify the weakening effect of this application on the magnetic field generated by the electrochemical apparatus 100, the following comparative tests were conducted.

### Test 1

With the first tab set as a positive electrode tab, the second tab set as a negative electrode tab, the included angle β set to 0°, the value of S4/S3 set to 100%, the included angle α set to 0°, the value of D1/D2 set to 0.9418, and the values of S2/S1 and the included angle θ changed, a magnetic flux density B on the side of the top wall 11 was recorded.

In this application, the magnetic flux density, also known as the magnetic induction intensity, can be used to indicate the strength of a magnetic field. A larger value of the magnetic flux density indicates a stronger magnetic field and a smaller weakening effect on the magnetic field generated by the electrochemical apparatus 100, while a smaller value of the magnetic flux density indicates a weaker magnetic field and a greater weakening effect on the magnetic field generated by the electrochemical apparatus 100.

TABLE 1
Comparison of records for different S2/S1

| | Included | | Included | Included | | Magnetic |
|---|---|---|---|---|---|---|
| S2/S1 | angle θ | S4/S3 | angle β | angle α | | flux density |
| (%) | (°) | (%) | (°) | (°) | D1/D2 | B/10⁻⁶ (T) |
| 100 | 0 | 100 | 0 | 0 | 0.9418 | 4.56 |
| 100 | 5 | 100 | 0 | 0 | 0.9418 | 4.75 |
| 100 | 10 | 100 | 0 | 0 | 0.9418 | 4.96 |
| 100 | 15 | 100 | 0 | 0 | 0.9418 | 5.19 |
| 100 | 20 | 100 | 0 | 0 | 0.9418 | 5.43 |
| 100 | 25 | 100 | 0 | 0 | 0.9418 | 5.68 |
| 95 | 30 | 100 | 0 | 0 | 0.9418 | 5.93 |
| 85 | 35 | 100 | 0 | 0 | 0.9418 | 6.18 |
| 70 | 40 | 100 | 0 | 0 | 0.9418 | 6.42 |
| 60 | 42 | 100 | 0 | 0 | 0.9418 | 6.51 |
| 55 | 45 | 100 | 0 | 0 | 0.9418 | 6.65 |
| 50 | 47 | 100 | 0 | 0 | 0.9418 | 6.73 |
| 45 | 49 | 100 | 0 | 0 | 0.9418 | 6.82 |
| 40 | 51 | 100 | 0 | 0 | 0.9418 | 6.90 |
| 35 | 52 | 100 | 0 | 0 | 0.9418 | 6.94 |
| 30 | 53 | 100 | 0 | 0 | 0.9418 | 6.97 |
| 20 | 55 | 100 | 0 | 0 | 0.9418 | 7.05 |
| 10 | 60 | 100 | 0 | 0 | 0.9418 | 7.21 |
| 0 | 70 | 100 | 0 | 0 | 0.9418 | 7.47 |
| 0 | 80 | 100 | 0 | 0 | 0.9418 | 7.75 |
| 0 | 90 | 100 | 0 | 0 | 0.9418 | 8.21 |
| 0 | 100 | 100 | 0 | 0 | 0.9418 | 8.92 |
| 0 | 110 | 100 | 0 | 0 | 0.9418 | 9.70 |
| 0 | 120 | 100 | 0 | 0 | 0.9418 | 10.30 |
| 0 | 130 | 100 | 0 | 0 | 0.9418 | 10.53 |
| 0 | 140 | 100 | 0 | 0 | 0.9418 | 10.44 |
| 0 | 150 | 100 | 0 | 0 | 0.9418 | 10.20 |
| 0 | 160 | 100 | 0 | 0 | 0.9418 | 9.93 |
| 0 | 170 | 100 | 0 | 0 | 0.9418 | 9.76 |
| 0 | 180 | 100 | 0 | 0 | 0.9418 | 9.83 |

It can be learned from Table 1 that when S2/S1 is 100% and θ is 0°, the magnetic flux density B is about 4.56×10⁻⁶ T; when S2/S1 is 50% and θ is 47°, the magnetic flux density B is about 6.73×10⁻⁶ T (about 1.48 times that when S2/S1 is 100% and θ is 0°); when S2/S1 is 0% and θ is 70°, the magnetic flux density B is about 7.47×10⁻⁶ T (about 1.64 times that when S2/S1 is 100% and θ is 0°); and when S2/S1 is 0% and θ is 180°, the magnetic flux density B is about 9.83×10⁻⁶ T (about 2.16 times that when S2/S1 is 100% and θ is 0°).

When S2/S1 is 100%, viewed in the third direction Z, a projection of the first connecting member 5 overlaps a projection of the first region A1, and the electrochemical apparatus 100 has good electromagnetic characteristics. Moreover, as the value of the included angle θ decreases, the electromagnetic characteristics of the electrochemical apparatus 100 are gradually optimized.

### Test 2

With the first tab set as a positive electrode tab, the second tab set as a negative electrode tab, the included angle θ set to 0°, the value of S2/S1 set to 100%, the included angle β set to 0°, and the values of S5/S3, the included angles α, and D1/D2 changed, the magnetic flux density B1 on the side of the top wall 11 and the magnetic flux density B2 on the side of the bottom wall 13 were recorded.

TABLE 2
Comparison of records for different S5/S3

| | | | Magnetic | Magnetic |
|---|---|---|---|---|
| | | | flux | flux |
| | Included | | density | density |
| S5/S3 | angle | | B1/10⁻⁶ | B2/10⁻⁶ |
| (%) | α (°) | D1/D2 | (T) | (T) |
| 100 | 0 | 0.9418 | 4.560 | 3.390 |
| 100 | 5 | 0.9406 | 4.590 | 3.445 |
| 100 | 10 | 0.9394 | 4.620 | 3.500 |
| 100 | 15 | 0.9382 | 4.650 | 3.555 |
| 100 | 20 | 0.9370 | 4.680 | 3.610 |
| 100 | 25 | 0.9358 | 4.710 | 3.665 |
| 95 | 30 | 0.9345 | 4.740 | 3.720 |
| 85 | 35 | 0.9333 | 4.915 | 3.852 |
| 70 | 40 | 0.9321 | 5.090 | 3.983 |
| 55 | 45 | 0.9309 | 5.265 | 4.115 |
| 40 | 50 | 0.9297 | 5.440 | 4.247 |
| 20 | 55 | 0.9285 | 5.615 | 4.378 |
| 10 | 60 | 0.9273 | 5.790 | 4.510 |
| 0 | 70 | 0.9249 | 5.840 | 4.623 |
| 0 | 80 | 0.9226 | 5.890 | 4.737 |
| 0 | 90 | 0.9202 | 5.940 | 4.850 |

It can be learned from Table 2 that when S5/S3 is 100% and α is 0°, the magnetic flux density B1 is about 4.560×10⁻⁶ T and the magnetic flux density B2 is about 3.390×10⁻⁶ T; when S5/S3 is 55% and a is 45°, the magnetic flux density B1 is about 5.265×10⁻⁶ T (about 1.15 times that when S5/S3 is 100% and α is 0°) and the magnetic flux density B2 is about 4.115×10⁻⁶ T (about 1.21 times that when S5/S3 is 100% and a is 0°); and when S5/S3 is 0% and a is 90°, the magnetic flux density B1 is about 5.940×10⁻⁶ T (about 1.30 times that when S5/S3 is 100% and a is 0°) and the magnetic flux density B2 is about 4.850×10⁻⁶ T (about 1.43 times that when S5/S3 is 100% and a is 0°).

When S5/S3 is 100%, viewed in the third direction Z, a projection of the second connecting member 6 overlaps a projection of the third region A3, and the electrochemical apparatus 100 has good electromagnetic characteristics. Moreover, as the value of a decreases, the electromagnetic characteristics of the electrochemical apparatus 100 are gradually optimized, and the magnetic flux densities on the sides of the top wall 11 and bottom wall 13 of the electrochemical apparatus 100 are further significantly decreased.

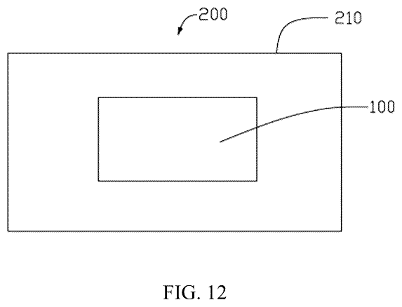

As shown in FIG. 12, an embodiment of this application further provides an electric device 200. The electric device 200 includes a device body 210 and the electrochemical apparatus 100 of any one of the foregoing embodiments, and the electrochemical apparatus 100 is disposed on the device body 210. The electrochemical apparatus 100 can weaken the magnetic field generated by itself, has good electromagnetic characteristics, and reduces the impact of its own magnetic field on the electric device 200.

In addition, persons skilled in the art can also make other changes within the spirit of this application. Certainly, these changes made according to the spirit of this application shall fall within the scope of this application.

What is claimed is:

1. An electrochemical apparatus, comprising:
a housing, wherein the housing comprises a top wall, a side wall, and a bottom wall, the top wall being provided with a first electrode; and
an electrode assembly accommodated in the housing, the electrode assembly comprising a first electrode plate and a second electrode plate;
wherein at least one of the following conditions (i) or (ii) is satisfied:
(i) the electrochemical apparatus further comprises:
a first tab connected to the first electrode plate and the first electrode, the first tab comprising a first connecting zone connected to the first electrode plate; and
a first connecting member disposed outside the housing, the first connecting member being connected to the first electrode; wherein
when viewed in a direction perpendicular to the top wall, a connecting line between a center of the first connecting zone and a center of the first electrode is a first reference line, and with the center of the first electrode as the center of a circle and a length L1 of a line segment between the center of the first connecting zone and the center of the first electrode as a radius, a ±45° sector region on both sides of the first reference line is denoted as a first region, an area of the first connecting member is denoted as S1, and an area of an overlap between the first connecting member and the first region is denoted as S2, wherein S2/S1≥50%; or
(ii) the electrochemical apparatus further comprises:
a second tab connected to the second electrode plate and the housing, the second tab comprising a second connecting zone connected to the second electrode plate and a third connecting zone connected to the housing; and
a second connecting member disposed outside the housing, the second connecting member being connected to the housing; wherein
when viewed in a direction perpendicular to the bottom wall, a connecting line between a center of the second connecting zone and a center of the third connecting zone is a second reference line, and with the center of the third connecting zone as the center of a circle and a length L2 of a line segment between the center of the second connecting zone and the center of the third connecting zone as a radius, a ±45° sector region on both sides of the second reference line is denoted as a second region, an area of the second connecting member is denoted as S3, and an area of an overlap between the second connecting member and the second region is denoted as S4, wherein S4/S3≥50%.

2. The electrochemical apparatus according to claim 1, wherein at least one of the following conditions (iii) or (iv) is satisfied:
(iii) S2/S1≥70%; or
(iv) S4/S3≥70%.

3. The electrochemical apparatus according to claim 1, wherein at least one of the following conditions (v) or (vi) is satisfied:
(v) a fourth connecting zone is provided at an end portion of the first connecting member away from the first electrode, wherein
when viewed in a direction perpendicular to the top wall, an angle between a connecting line between a center of the fourth connecting zone and the center of the first electrode and a connecting line between the center of the first connecting zone and the center of the first electrode is denoted as θ, and 0°≤θ≤45°; or
(vi) a fifth connecting zone is provided at an end portion of the second connecting member away from the third connecting zone, wherein
when viewed in a direction perpendicular to the bottom wall, an angle between a connecting line between a center of the fifth connecting zone and the center of the third connecting zone and a connecting line between the center of the second connecting zone and the center of the third connecting zone is denoted as β, and 0°≤β≤45°.

4. The electrochemical apparatus according to claim 1, wherein
a fourth connecting zone is provided at an end portion of the first connecting member away from the first electrode, wherein
when viewed in a direction perpendicular to the top wall, a connecting line between a center of the fourth connecting zone and the center of the first electrode is a third reference line, and with the center of the first electrode as the center of a circle and a length L3 of a line segment between the center of the fourth connecting zone and the center of the first electrode as a radius, a ±45° sector region on both sides of the third reference line is denoted as a third region, and an area of an overlap between the second connecting member and the third region is denoted as S5, and S5/S3≥50%.

5. The electrochemical apparatus according to claim 4, wherein a ratio of the area S5 to the area S3 satisfies: S5/S3≥85%.

6. The electrochemical apparatus according to claim 4, wherein when viewed in the direction perpendicular to the top wall, an angle between the first reference line and the second reference line is denoted as α, and 0°≤α≤60°.

7. The electrochemical apparatus according to claim 1, wherein
the electrode assembly is a wound structure;
the first electrode plate comprises a first active material layer, the first active material layer comprises a first end portion, and the first end portion is disposed at a winding start end of the wound structure;
the second electrode plate comprises a second active material layer, the second active material layer comprises a second end portion, and the second end portion is disposed at the winding start end of the wound structure; and
along a length direction of the first electrode plate, a distance between the center of the first connecting zone and the first end portion is denoted as D1; and along a length direction of the second electrode plate, a distance between the center of the second connecting zone and the second end portion is denoted as D2, and 0.5≤D1/D2≤2.

8. The electrochemical apparatus according to claim 1, wherein at least one of the following conditions (a) or (b) is satisfied:
(a) a fourth connecting zone is provided at an end portion of the first connecting member away from the first electrode, wherein when viewed in a direction perpendicular to the top wall, a length of a line segment between a center of the fourth connecting zone and the center of the first electrode is denoted as L3, and 0.5≤L1/L3≤2; or
(b) a fifth connecting zone is provided at an end portion of the second connecting member away from the third connecting zone, wherein when viewed in a direction perpendicular to the bottom wall, a length of a line segment between a center of the fifth connecting zone and the center of the third connecting zone is denoted as L4, and 0.5≤L2/L4≤2.

9. The electrochemical apparatus according to claim 1, wherein at least one of the following conditions (1) to (4) is satisfied:
(1) the first tab and the second tab are located on opposite sides of the electrode assembly;
(2) the top wall has a first surface and a second surface opposite to each other, the top wall is provided with a through hole penetrating through the first surface and the second surface, and the first electrode is disposed in the through hole;
(3) an insulator is provided between the top wall and the first electrode; or
(4) the housing comprises a metal material.

10. An electric device, comprising an electrochemical apparatus, the electrochemical apparatus comprises:
a housing, wherein the housing comprises a top wall, a side wall, and a bottom wall, the top wall being provided with a first electrode; and
an electrode assembly accommodated in the housing, the electrode assembly comprising a first electrode plate and a second electrode plate;
wherein at least one of the following conditions (i) or (ii) is satisfied:
(i) the electrochemical apparatus further comprises:
a first tab connected to the first electrode plate and the first electrode, the first tab comprising a first connecting zone connected to the first electrode plate; and
a first connecting member disposed outside the housing, the first connecting member being connected to the first electrode; wherein
when viewed in a direction perpendicular to the top wall, a connecting line between a center of the first connecting zone and a center of the first electrode is a first reference line, and with the center of the first electrode as the center of a circle and a length L1 of a line segment between the center of the first connecting zone and the center of the first electrode as a radius, a ±45° sector region on both sides of the first reference line is denoted as a first region, an area of the first connecting member is denoted as S1, and an area of an overlap between the first connecting member and the first region is denoted as S2, wherein S2/S1≥50%; or
(ii) the electrochemical apparatus further comprises:
a second tab connected to the second electrode plate and the housing, the second tab comprising a second connecting zone connected to the second electrode plate and a third connecting zone connected to the housing; and
a second connecting member disposed outside the housing, the second connecting member being connected to the housing; wherein
when viewed in a direction perpendicular to the bottom wall, a connecting line between a center of the second connecting zone and a center of the third connecting zone is a second reference line, and with the center of the third connecting zone as the center of a circle and a length L2 of a line segment between the center of the second connecting zone and the center of the third connecting zone as a radius, a ±45° sector region on both sides of the second reference line is denoted as a second region, an area of the second connecting member is denoted as S3, and an area of an overlap between the second connecting member and the second region is denoted as S4, wherein S4/S3≥50%.

11. The electric device according to claim 10, wherein at least one of the following conditions (iii) or (iv) is satisfied:
(iii) S2/S1≥70%; or
(iv) S4/S3≥70%.

12. The electric device according to claim 10, wherein at least one of the following conditions (v) or (vi) is satisfied:
(v) a fourth connecting zone is provided at an end portion of the first connecting member away from the first electrode, wherein
when viewed in a direction perpendicular to the top wall, an angle between a connecting line between a center of the fourth connecting zone and the center of the first electrode and a connecting line between the center of the first connecting zone and the center of the first electrode is denoted as θ, and 0°≤θ≤45°; or
(vi) a fifth connecting zone is provided at an end portion of the second connecting member away from the third connecting zone, wherein
when viewed in a direction perpendicular to the bottom wall, an angle between a connecting line between a center of the fifth connecting zone and the center of the third connecting zone and a connecting line between the center of the second connecting zone and the center of the third connecting zone is denoted as β, and 0°≤β≤45°.

13. The electric device according to claim 10, wherein
a fourth connecting zone is provided at an end portion of the first connecting member away from the first electrode, wherein
when viewed in a direction perpendicular to the top wall, a connecting line between a center of the fourth connecting zone and the center of the first electrode is a third reference line, and with the center of the first electrode as the center of a circle and a length L3 of a line segment between the center of the fourth connecting zone and the center of the first electrode as a radius, a ±45° sector region on both sides of the third reference line is denoted as a third region, and an area of an overlap between the second connecting member and the third region is denoted as S5, and S5/S3≥50%.

14. The electric device according to claim 13, wherein a ratio of the area S5 to the area S3 satisfies: S5/S3≥85%.

15. The electric device according to claim 13, wherein when viewed in the direction perpendicular to the top wall, an angle between the first reference line and the second reference line is denoted as α, and 0°≤α≤60°.

16. The electric device according to claim 10, wherein
the electrode assembly is a wound structure;
the first electrode plate comprises a first active material layer, the first active material layer comprises a first end portion, and the first end portion is disposed at a winding start end of the wound structure;
the second electrode plate comprises a second active material layer, the second active material layer comprises a second end portion, and the second end portion is disposed at the winding start end of the wound structure; and
along a length direction of the first electrode plate, a distance between the center of the first connecting zone and the first end portion is denoted as D1; and along a length direction of the second electrode plate, a distance between the center of the second connecting zone and the second end portion is denoted as D2, and 0.5≤D1/D2≤2.

17. The electric device according to claim 10, wherein at least one of the following conditions (a) or (b) is satisfied:
(a) a fourth connecting zone is provided at an end portion of the first connecting member away from the first electrode, wherein when viewed in a direction perpendicular to the top wall, a length of a line segment between a center of the fourth connecting zone and the center of the first electrode is denoted as L3, and 0.5≤L1/L3≤2; or
(b) a fifth connecting zone is provided at an end portion of the second connecting member away from the third connecting zone, wherein when viewed in a direction perpendicular to the bottom wall, a length of a line segment between a center of the fifth connecting zone and the center of the third connecting zone is denoted as L4, and 0.5≤L2/L4≤2.

18. The electric device according to claim 10, wherein at least one of the following conditions (1) to (4) is satisfied:
(1) the first tab and the second tab are located on opposite sides of the electrode assembly;
(2) the top wall has a first surface and a second surface opposite each other, the top wall is provided with a through hole penetrating through the first surface and the second surface, and the first electrode is disposed in the through hole;
(3) an insulator is provided between the top wall and the first electrode; or
(4) the housing comprises a metal material.
